(19) United States
(12) Patent Application Publication
(10) Pub. No.: US 2025/0377771 A1
(43) Pub. Date: Dec. 11, 2025

(54) OBJECT SELECTING METHOD, APPARATUS AND ELECTRONIC DEVICE

(71) Applicant: NETEASE (HANGZHOU) NETWORK CO., LTD., Hangzhou (CN)

(72) Inventor: Weinan LI, Hangzhou (CN)

(21) Appl. No.: 18/877,881

(22) PCT Filed: Apr. 28, 2023
(86) PCT No.: PCT/CN2023/091470

§ 371 Date: Dec. 20, 2024

(30) Foreign Application Priority Data
Jun. 24, 2022 (CN) 202210731386.8

(51) Int. Cl. G06F 3/04842; G06F 3/0488; G06T 7/70

(52) U.S. Cl. CPC G06F 3/04842; G06F 3/0488; G06T 7/70

(57) ABSTRACT

The present disclosure provides an object selection method. The method includes: in response to a target object appearing in a graphical user interface, acquiring an object position of the target object in the graphical user interface; setting an interaction area corresponding to the target object in the graphical user interface based on the object position, where the interaction area being larger than a display area of the target object in the graphical user interface; and selecting the target object in response to a specified trigger operation acting on the interaction area.

### CROSS-REFERENCE TO RELATED APPLICATIONS

The present disclosure is a 371 national phase application of PCT Application No. PCT/CN2023/091470 filed Apr. 28, 2023, which claims priority to Chinese Patent Application No. 202210731386.8 titled “OBJECT SELECTING METHOD, APPARATUS AND ELECTRONIC DEVICE” and filed on Jun. 24, 2022, the entire contents of both of which applications are hereby incorporated by reference for all purposes.

### TECHNICAL FIELD

The present disclosure relates to the technical field of games, and particularly relates to an object selecting method, apparatus, and electronic device.

### BACKGROUND

In some mobile games, virtual objects will appear in the game scene. Players need to select the target object from the virtual objects, and then perform operations such as releasing skills, chatting, and trading on the selected target object. However, since virtual objects are relatively small, the touch range of the object selection operation is relatively small; when the virtual objects in the game scene are moving, or when multiple virtual objects appear in the game scene at the same time and overlap with each other, it is difficult for players to successfully perform the object selection operation, and it is often necessary to perform the object selection operation multiple times before the target object can be successfully selected, resulting in a heavy operation burden of selecting an object, which reduces the game experience of players. The increased operation burden prolongs the running time of the terminal device and consumes the power of the terminal device.

It should be noted that the information disclosed in the above background section is only used to enhance the understanding of the background of the present disclosure, and therefore may include information that does not constitute related technology known to those of ordinary skill in the art.

### SUMMARY

The present disclosure provides an object selecting method, apparatus, and electronic device, to select an object in virtual game scenes conveniently and efficiently.

According to a first aspect, the present disclosure provides a method for selecting an object. The method comprises: acquiring, in response to a target object appearing in a graphical user interface of a terminal device, an object position of the target object in the graphical user interface; setting, based on the object position, an interaction area corresponding to the target object in the graphical user interface, where the interaction area is larger than a display area of the above-mentioned target object in the graphical user interface; and selecting, in response to a specified trigger operation acting on the interaction area, the target object.

According to a second aspect, the present disclosure provides a system, comprising one or more memories collectively containing one or more programs, and one or more processors, where the one or more processors are configured to, individually or collectively, perform the operations in the above-mentioned method for selecting an object.

According to a third aspect, the present disclosure provides one or more non-transitory computer-readable storage media containing, in any combination, computer program code that, when executed by a computer system, performs the operations in the above-mentioned method for selecting an object.

### BRIEF DESCRIPTION OF THE DRAWINGS

In order to more clearly illustrate the technical solutions in the embodiments of the present disclosure, the drawings required for use in the description of the embodiments will be briefly introduced below. Apparently, the drawings described below are merely some embodiments of the present disclosure. For those skilled in the art, other drawings may also be obtained based on these drawings without creative work.

FIG. 1 is a schematic diagram of a scene of selecting an object provided by one embodiment of the present disclosure;

FIG. 2 is a flowchart of a method for selecting an object provided by one embodiment of the present disclosure;

FIG. 3 is a schematic diagram of location information of a target object in a graphical user interface provided by one embodiment of the present disclosure;

FIG. 4 is a schematic diagram showing setting an interaction area provided by one embodiment of the present disclosure;

FIG. 5 is a schematic diagram of an interaction area in a graphical user interface provided by one embodiment of the present disclosure;

FIG. 6 is a schematic diagram of another interaction area in a graphical user interface provided by one embodiment of the present disclosure;

FIG. 7 is a schematic diagram showing existence of multiple objects in a graphical user interface provided by one embodiment of the present disclosure;

FIG. 8 is a schematic diagram of an interaction area corresponding to multiple objects in a graphical user interface provided by one embodiment of the present disclosure;

FIG. 9 is a schematic diagram showing selecting multiple objects in a graphical user interface provided by one embodiment of the present disclosure;

FIG. 10 is a schematic diagram of an adjusted interaction area in a graphical user interface provided by one embodiment of the present disclosure;

FIG. 11 is a schematic diagram of another adjusted interaction area in a graphical user interface provided by one embodiment of the present disclosure;

FIG. 12 is a schematic structural diagram of an apparatus for selecting an object provided by one embodiment of the present disclosure;

FIG. 13 is a schematic diagram of an electronic device for selecting an object provided by one embodiment of the present disclosure.

### DETAILED DESCRIPTION

In order to make the objectives, technical solutions, and advantages of embodiments of the present disclosure clearer, the technical solutions in the present disclosure will be clearly and completely described below with reference to the drawings. Apparently, the described embodiments are some, instead of all, of the embodiments of the present disclosure. Based on the embodiments in the present disclosure, all other embodiments obtained by those skilled in the art without making any creative work shall fall within the scope of protection of the present disclosure.

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components that are directly or indirectly linked together, so as to perform a particular function.

The disclosed method, apparatus, and electronic device for object selection operate as follows: in response to a target object appearing in a graphical user interface, acquire an object position of the target object in the graphical user interface; set, based on the object position, an interaction area corresponding to the target object in the graphical user interface, where the interaction area is larger than a display area of the target object in the graphical user interface; and select, in response to a specified trigger operation acting on the interaction area, the target object. In the disclosed embodiments, the interaction area of the target object is set in the interface based on the object position of the target object. The interaction area is larger than the display area of the target object, enabling the target object to be selected by interacting with the expanded interaction area. This approach increases the operable area for object selection, allowing for convenient and efficient selection with a high success rate. Additionally, the approach reduces the operation burden of selecting an object, improves the game experience of the player, reduces the terminal device's running time, and saves its power consumption.

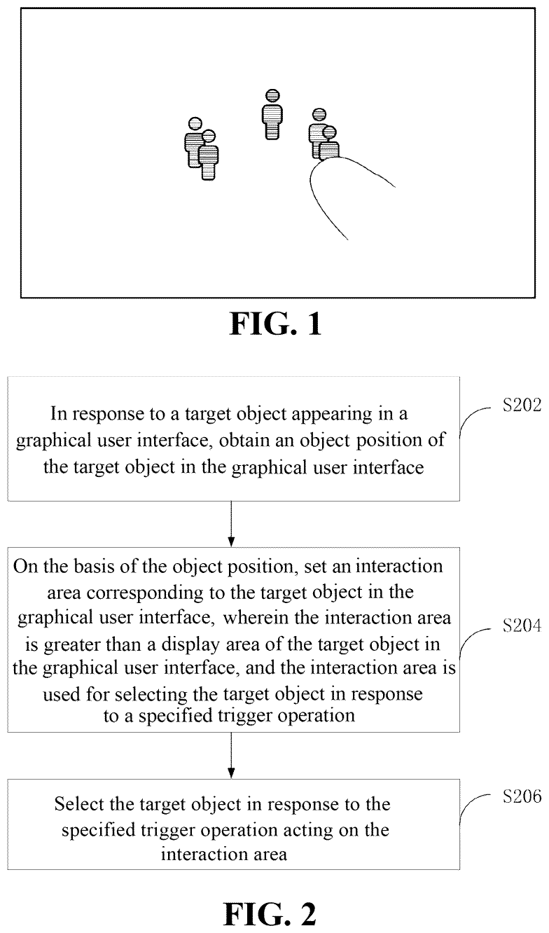

In some mobile games, selecting a target object is the basis for players to execute operations such as releasing skills and chatting. However, the virtual objects in the game scene are relatively small, resulting in a relatively small touch range for the object selection operation, which increases the difficulty for players in selecting the target object. When the virtual object moves in the game picture, or multiple virtual objects appear in the game picture and the multiple virtual objects overlap, as shown in FIG. 1, it is difficult for players to accurately select the target object when executing a click operation. In addition, when the target object appears in the middle of the picture, the player needs to move his or her finger to the center to click, and the operation is less convenient.

In summary, the success rate of player's object selection operation is low and the operation convenience is poor, which leads to a heavy operation burden of selecting an object and reduces the player's game experience and fun.

Based on this, the embodiments of the present disclosure provide an object selecting method, apparatus and electronic device. This technology can be applied to scenes in various games where objects need to be selected, such as selecting a target of attack, selecting a teammate to interact with or rescue.

The method for selecting an object in one embodiment of the present disclosure may be run on a terminal device or a server, and the terminal device may be a touch terminal device. When the method for selecting an object runs on a server, the method can be implemented and executed based on a cloud interaction system, where the cloud interaction system includes the server and a client device.

In some embodiments, various cloud applications, such as cloud games, can be run under the cloud interaction system. Taking a cloud game as an example, the cloud game refers to a game mode based on cloud computing. In the cloud game operation mode, an operation subject of a game program and a game picture presentation subject are separated. The storage and operation of the method for selecting the object are completed on the cloud game server. The client device is used for receiving and sending data and presenting the game picture. For example, the client device can be a display device which is close to a user and has a data transmission function, such as a mobile terminal, a television, a computer and a palmtop; but the cloud game server in the cloud is responsible for information processing. When playing a game, the player operates the client device to send an operation instruction to the cloud game server, then the cloud game server runs the game according to the operation instruction, data such as the game pictures are encoded and compressed and returned to the client device through a network, and finally the game pictures are decoded and outputted through the client device.

In some embodiments, taking games as an example, the terminal device stores the game program and is used to present the game picture. The terminal device is configured to interact with the player through a graphical user interface, namely, the game program is downloaded, installed and operated through an electronic device conventionally. The terminal device provides the graphical user interface for the player in various modes, such as rendering and displaying it on the terminal's display screen, or providing it to players through holographic projection. For example, the terminal device may include a display screen and a processor, the display screen is configured to present the graphical user interface, the graphical user interface includes the game picture, and the processor is configured to run the game, generate the graphical user interface and control the display of the graphical user interface on the display screen.

Embodiments of the present disclosure provide a method for selecting an object, which provides a graphical user interface through a terminal device, where the terminal device may be the terminal devices mentioned above, or may be a client device in the cloud interaction system mentioned above. A graphical user interface is provided through the terminal device, and the graphical user interface can display interface content, such as a game scene picture, a communication interaction window according to the type of the application program started.

To facilitate understanding of the present embodiment, a method for selecting an object disclosed in an embodiment of the present disclosure is first introduced in detail. As shown in FIG. 2, the method for selecting an object provides a graphical user interface through a terminal device, where the terminal device may be the local terminal device described above or the client device described above. The method includes the following steps:

Step S202, acquiring, in response to a target object appearing in the graphical user interface, an object position of the target object in the graphical user interface;

The target object that appears in the graphical user interface may specifically be a virtual object existing in the game scene. For example, the target object may be a controlled virtual object of the player's own controls, an object of attack, an NPC (non-player character). For another example, in a team combat game, the target object may be an enemy object in the game scene, or a teammate, or an NPC.

Only one target object may appear in the graphical user interface, or multiple target objects may appear at the same time. When the target object appears in the graphical user interface, the object position of the target object in the graphical user interface is acquired, where the object position may include: the position coordinate information of the target object in the graphical user interface, specifically the position coordinate information of the edge point (for example, vertex) corresponding to the target object. In some embodiments, the three-dimensional position information of the target object in the game scene can be acquired first, and then the three-dimensional position information can be mapped to the two-dimensional space of the scene picture based on to the shooting parameters of the virtual camera to obtain the position information of the target object in the scene picture, which is the position information of the target object in the graphical user interface.

Step S204, setting, based on the object position, an interaction area corresponding to the target object in the graphical user interface; where the interaction area is larger than a display area of the target object in the graphical user interface, and the interaction area is used for: selecting, in response to a specified trigger operation, the target object;

Specifically, a target object is displayed in a graphical user interface, and the area occupied by the target object in the graphical user interface is the display area of the target object. In a combat game scene under a 3D (3-dimensional) viewing angle, since the virtual camera is usually far away from the virtual object and the virtual scene is photographed in a wide viewing angle, the area occupied by each virtual object in the graphical user interface is usually relatively small, and the display area of the target object is also relatively small.

In the embodiment, an interaction area corresponding to the target object is set in the graphical user interface based on the object position of the target object. The interaction area is specifically used for: selecting the target object in response to a specified trigger operation after the player executes the specified trigger operation. The above-mentioned specified trigger operation can be operations such as click and double-click. In order to facilitate players to execute the specified trigger operation for selecting the target, the set interaction area is greater than the display area of the target object in the graphical user interface. Based on this, the player can select the target object through the larger interaction area. When the target object appears in the middle position of the graphical user interface, or the target object is moving, or there are other virtual objects around the target object, the player can also quickly and accurately select the target object, which reduces the operation burden of the player to select the object, improves the game experience of the player, reduces the running time of the terminal device, and saves the power consumption of the terminal device.

There are many modes to set the interaction area. In one mode or embodiment, the graphical user interface may be divided into multiple areas according to the positions of the target objects in the game scene. The multiple areas may overlap or may not overlap, and each target object corresponds to an area serving as the interaction area of the target object. Each interaction area may be identified and displayed in the graphical user interface by means of color, frame or text. In this configuration, the shape or size of the interaction area may have a certain degree of randomness, but usually, the interaction area is related to the position of the corresponding target object. For example, the position of the interaction area changes as the position of the target object changes, or the size of the interaction area changes as the position of the target object changes.

The interaction area may not be displayed in the graphical user interface. In this case, the player may be informed in advance of the rules for setting the interaction area. The setting rules may include the size of the interaction area, the way it changes as the position of the target object changes, etc. This allows players to directly determine the interaction area of the target object through the position of the target object. But usually, the interaction area is greater than the display area of the target object. In one mode or embodiment, the display area of the target object is included in the interaction area, and the interaction area also includes part of the scene area; in another mode or embodiment, the display area of the target object is located outside the interaction area.

The purpose of this embodiment is to provide a new method for selecting an object. Based on the position information of the target object, an interaction area corresponding to the target object is set. The interaction area is greater than the display area of the target object in the graphical user interface. The player can select the target object by executing a specified trigger operation in the interaction area. Based on this, the area for the player to select the object is expanded, which is convenient for the player's operation and increases the game experience and fun.

Step S206, selecting, in response to the specified trigger operation acting on the interaction area, the target object.

Players can select a target object based on the state of a virtual object that appears in the graphical user interface or the current game state. For example, if an enemy object with low blood volume appears in the game scene picture, the player can identify the enemy object as the target object. Or, when a teammate of their own who is in poor condition appears in the graphical user interface and the player wants to rescue the teammate, the player can identify the teammate as the target object.

In some embodiments, as long as the player performs a specified trigger operation in the interaction area, the target object corresponding to the interaction area will be selected in response to the specified trigger operation. The player can then execute subsequent operations on the target object. For example, when the target object is an enemy object, the player can release skills to cause damage to the target object after selecting the target object; when the target object is a teammate, the player can help the teammate recover after selecting the target object.

When the target object is selected, the specified trigger operation for the interaction area may be the same as or different from the trigger operation for the target object; the specified trigger operation may include specific operations such as single-click, double-click, and long-press.

The above-mentioned method for selecting an object, in response to a target object appearing in a graphical user interface, acquires an object position of the target object in the graphical user interface; based on the object position, sets an interaction area corresponding to the target object in the graphical user interface, where the interaction area is larger than a display area of the target object in the graphical user interface, and the interaction area is used for: selecting, in response to a specified trigger operation, the target object; and selects the target object in response to the specified trigger operation acting on the interaction area. In the mode or embodiment, the interaction area of the target object is set in the interface based on the object position of the target object, the interaction area is greater than the display area of the target object, and the target object can be selected by triggering the interaction area; this method can expand the operable area for selecting an object, and the object can be selected conveniently and efficiently, the operation success rate of selecting an object is high, which reduces the operation burden of selecting an object, improves the game experience of the player, reduces the running time of the terminal device, and saves the power consumption of the terminal device.

The following embodiment provides a method for acquiring the object position of the target object in the graphical user interface.

In response to the target object appearing in the graphical user interface, a capsule of the object model of the target object in the game scene is acquired; a capsule planar area of the capsule in the scene picture displayed in the graphical user interface is determined, and position information of a specified position point relative to the capsule planar area is determined as the object position of the target object in the graphical user interface.

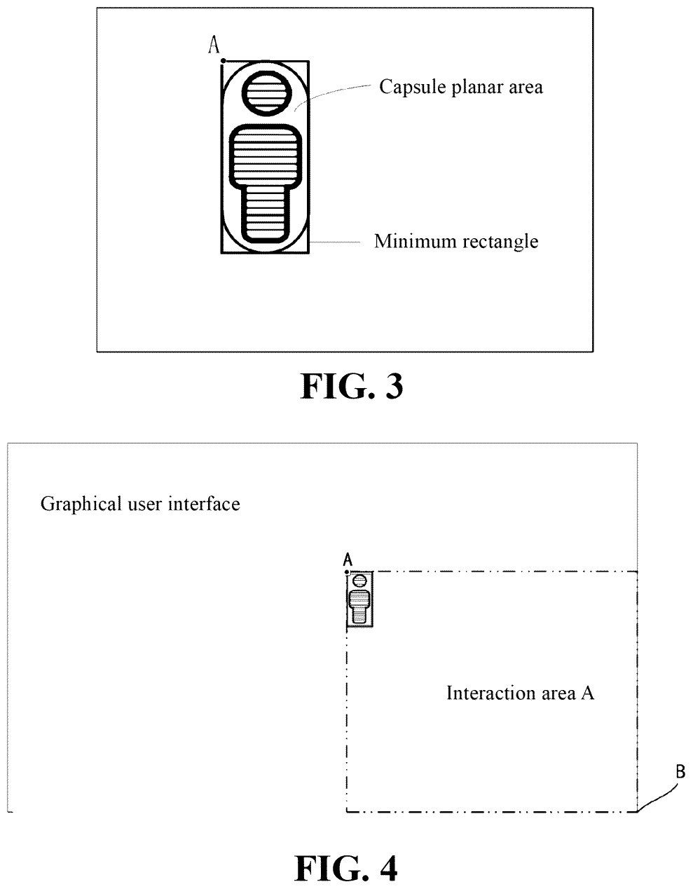

In some embodiments, virtual objects in the game scene have corresponding models. When developers create the model, they will also create a three-dimensional capsule model that is invisible to the camera and matches the size of the virtual object model. When a target object appears in the graphical user interface and the object position of the target object needs to be acquired, a capsule of the object model of the target object in the game scene is acquired. Further, the capsule is projected in the graphical user interface to determine the capsule planar area of the capsule in the scene picture displayed in the graphical user interface, as shown in FIG. 3. Then, a minimum rectangle is drawn in the capsule planar area. The length of the minimum rectangle is the length of the capsule projection, the width of the minimum rectangle is the width of the capsule projection, and the above-mentioned minimum rectangle contains the capsule projection inside the rectangle.

Furthermore, a capsule planar area of the capsule in the scene picture displayed in the graphical user interface is determined; and a position point in the direction of the upper left corner of the capsule planar area is determined as the object position of the target object in the graphical user interface. Specifically, the specified position point relative to the capsule planar area may be the vertex of the upper left corner of the minimum rectangle. In some embodiments, it may also be other position points in the direction of the upper left corner of the capsule planar area. When the specified position point is the vertex of the upper left corner of the minimum rectangle, the vertex position of the upper left corner of the minimum rectangle is determined as the object position of the target object in the graphical user interface.

The following embodiment provides a specific implementation for acquiring the object position of the target object in the graphical user interface.

In response to target objects appearing in the graphical user interface, statistics are performed on the distribution state of the target objects appearing in the graphical user interface; where the distribution state includes the number and/or density of the target objects; in response to the distribution state satisfying a preset condition, the object position of the target object in the graphical user interface is acquired.

The distribution state may include both the object number and density of target objects, or may include only one of the object number or the density. In some embodiments, there may be one or more target objects appearing in the graphical user interface. The difficulty for the player in selecting a target object may vary depending on the number of target objects appearing in the graphical user interface and the density of the multiple target objects. Specifically, when the number of target objects appearing in the graphical user interface is small and the target objects are sparsely distributed, the player's success rate in selecting the target object is the highest. When the number of target objects appearing in the graphical user interface is large and the target objects are densely distributed, it will be more difficult for the player to successfully select the target object.

In order to reduce the difficulty for the player in selecting the target object, in this embodiment, when the target objects appear in the graphical user interface, the distribution state of the target objects appearing in the graphical user interface is analyzed statistically, and the distribution state includes the number and density of the target objects. The density can be represented by level one, level two, and level three, corresponding to sparse, relatively sparse, dense, respectively. When the above distribution state meets the preset conditions, the position information of the target object in the graphical user interface is acquired.

In one mode or embodiment, one target object appears in the graphical user interface. In this case, the distribution state of the target objects in the graphical user interface is as follows: the number of target objects is 1, the density is relatively small, and it can be sparse. In this case, there is no need to obtain the object position of the target object and set the interaction area based on the object position, and the target object can be directly selected through the display area of the target object.

In another mode or embodiment, multiple target objects may appear in the graphical user interface. In this case, in the distribution state of the target objects in the graphical user interface, there are multiple target objects and the density is relatively high. In this case, the object position of the target object in the graphical user interface is acquired, and then an interaction area is generated based on the object position to expand the interaction range for selecting the target object.

It should be noted that as long as the target object appears in the graphical user interface, an interaction area corresponding to the target object will be generated, and when the target object moves, the interaction area corresponding to the target object will also move accordingly. When there are few target objects or the density is small, there is no need to acquire the object position of the target object; when there are many target objects or the density is large, the object position of the target object is acquired to generate the interaction area, and the player can be prompted by a prompt message that the interaction area of the target object has been generated, or the interaction area can be displayed in the graphical user interface by means of an area mark.

In the above mode, the object position of the object is acquired only when there are many or dense objects, and then the interaction area is set based on the object position, thereby improving the success rate of the operation of selecting an object when there are many objects.

The following embodiment provides a specific implementation for setting the interaction area corresponding to the target object.

Specifically, based on the object position and a datum position in the graphical user interface, the interaction area corresponding to the target object is set in the graphical user interface; where the datum position is used to determine the interaction area in the graphical user interface together with the object position.

In some embodiments, the interaction area corresponding to the target object is set in the graphical user interface based on the object position of the target object. Specifically, the interaction area corresponding to the target object can be set based on the object position of the target object and the datum position in the graphical user interface together. In order to make the set interaction area more in line with the player's operation habits, the datum position is determined based on the trigger position of the historical trigger operation, and then the interaction area corresponding to the target object is set based on the object position of the target object and the above-mentioned datum position. Based on this, the player only needs to execute the specified trigger operation at any position in the interaction area to select the target object corresponding to the interaction area, which expands the area for the player to select the object and reduces the difficulty for the player in selecting the object.

In some embodiments, if the trigger positions of historical trigger operations are mainly distributed in the right area of the graphical user interface, the datum position can be determined from the right area, for example, the datum position is the lower right corner position of the graphical user interface, or a specified position on the right edge. In another mode, if the trigger positions of historical trigger operations are mainly distributed in the left area of the graphical user interface, the datum position can be determined from the left area, for example, the datum position is the lower left corner position of the graphical user interface, or a specified position on the left edge.

Since the trigger positions of historical trigger operations can represent the player's operation habits, an area with more trigger positions can be understood as the boundary area for the player to operate; therefore, determining a datum position based on the trigger positions of historical trigger operations, and then determining an interaction area based on the datum position, can make the interaction area more in line with the player's operation habits.

Furthermore, the object position and the datum position in the graphical user interface are used as reference positions to generate the interaction area of a specified shape; where the display area of the target object in the graphical user interface is included in the interaction area.

The target object occupies a certain display area in the graphical user interface, and the position point corresponding to the above-mentioned object position can be determined in the display area, for example, the position point at the upper left corner or the lower right corner of the display area. In some embodiments, the object model of the target object in the virtual scene is usually provided with a corresponding three-dimensional capsule, and the three-dimensional capsule is projected in the graphical user interface to form a two-dimensional graphic. A minimum rectangle is drawn for the two-dimensional graphic, and the projection of the capsule model can be included inside the minimum rectangle. The position point corresponding to the above object position can be the vertex of the above minimum rectangle, for example, the vertex of the upper left corner, the vertex of the upper right corner.

Then, the above position point and the datum position in the graphical user interface are used as reference positions to generate the interaction area of a specified shape. In some embodiments, the above specified shape may be a rectangle. In addition, the generated interaction area will include the display area of the target object. As an example, when the specified shape is a rectangle, the position point corresponding to the position information of the target object is a point located at the upper left corner of the display area of the target object, such as point A, and the datum position is a point at the lower right corner of the graphical user interface, such as point B. Point A and point B, as the opposite corners of the rectangle, can uniquely determine a rectangle, which is the interaction area of the target object. At the same time, since point A is located at the upper left corner of the display area of the target object, the display area of the target object is included in the interaction area.

As depicted in FIG. 4, when the target object is in the middle or to the right of the graphical user interface, considering that the user usually uses the right hand to perform the specified trigger operation for selecting the target object, which is the above-mentioned datum position is in the right area of the graphical user interface, in some embodiments, point A in the figure and the vertex of the lower right corner of the graphical user interface are used as reference positions to generate an interaction area as a touchable rectangle for selecting the target object. In the interaction area, point A is the vertex of the upper left corner, and the opposite corner of point A is located at the lower right corner of the graphical user interface. Based on this, an interaction area A is created, and the player can select the target object by clicking anywhere in the interaction area A.

In another mode or embodiment, a touchable rectangle may be generated as the interaction area based on the vertex of the upper right corner of the minimum rectangle and the lower left corner of the graphical user interface. For example, when the target object is located near the left side of the graphical user interface, at that time, the vertex of the upper right corner of the minimum rectangle is used as the vertex of the upper right corner of the interaction area, and the opposite corner of that point is located at the lower left corner of the graphical user interface.

In this embodiment, an interaction area that is convenient for players to operate can be generated based on the position information of the target object. For example, if the target object is located on the right side, the interaction area is generated on the right side, as shown in FIG. 4, and if the target object is located on the left side, the interaction area is generated on the left side. As long as the target object appears in the graphical user interface, the corresponding interaction area will appear. When the target object moves in the graphical user interface, the interaction area will also move or deform accordingly.

In the mode, the interaction area of a specified shape is generated by using the position point in the object position and the datum position as reference positions. The player can select the target object without moving the finger significantly, which improves the convenience of the player's operation of selecting an object.

It should be noted that in mobile games, mobile controls are set on the left side of the graphical user interface, and players operate the mobile controls with their left thumb to control the movement of the controlled virtual object; at the same time, skill controls are set on the right side of the graphical user interface; players select the target object with their right thumb, and then perform operations on the selected target object, such as releasing skills, and communication; specifically, when selecting the target object, the player uses the right thumb to single-click or double-click on the display area of the target object itself. However, due to the large area of the touch screen, the virtual objects in the game scene may be distributed at various positions of the scene. At the same time, the length of the right thumb is very limited. When the player is selecting the virtual object with the right thumb, it is difficult to accurately click the target object itself, and it is easy to make a wrong selection. The player needs to stretch out the right thumb and execute the click operation multiple times before the target object can be correctly selected, which is not convenient to operate.

In order to solve the above problem, in this embodiment, an interaction area is generated in the lower right area of the target object. Through the lower right area of the target object, the player's right thumb can quickly select the object without much effort, which greatly improves the success rate of selecting a target object, thereby improving the game experience of the player, reducing the running time of the terminal device, and saving power consumption of the terminal device.

Based on the above, the datum position in the graphical user interface is located in the direction of the lower right corner of the graphical user interface; based on the object position and the datum position, a rectangular area is generated; where the object position and the datum position are corners opposite to each other in the rectangular area; and the above-mentioned rectangular area is determined as the interaction area corresponding to the target object.

In one mode or embodiment, the above-mentioned object position can specifically be the upper left corner position point of the capsule planar area of the target object. In this configuration, the target object is provided with a capsule in the game scene, and the capsule corresponds to the capsule planar area in the scene picture. A minimum circumscribed rectangle is set for the capsule planar area, and the object position is the upper left corner point of the minimum circumscribed rectangle. In some embodiments, the above-mentioned object position may also be other position points in the direction of the upper left corner of the target object.

Since the graphical user interface is a rectangle, the above-mentioned datum position may be a position point at the lower right corner of the graphical user interface, or may be other position points in the direction of the lower right corner of the graphical user interface. A rectangular area can be generated based on the object position and the datum position. In the rectangular area, the object position and the datum position are corners opposite to each other. In this configuration, the line connecting the object position and the datum position is the diagonal line of the rectangular area. The rectangular area is the interaction area corresponding to the target object.

In the example of FIG. 4, point A is the object position in the direction of the upper left corner of the target object; point B is the lower right corner point of the graphical user interface, which is the datum position. Point A and point B are the opposite corners of the rectangular interaction area A.

In the above mode, the interaction area of the target object is much greater than the display area of the target object, which makes it easier for the player to accurately select the target object.

The following embodiment provides a method for setting an interaction area and a method for selecting a target object when multiple target objects overlap.

In a specific mode, the above-mentioned target object includes a first object and a second object; in response to the display area of the first object blocking the display area of the second object, an overlapping area between a first interaction area of the first object and a second interaction area of the second object is determined, where the first interaction area is used for: selecting the first object in response to a specified trigger operation; and the second object is selected in response to a specified trigger operation in the remaining area outside the overlapping area in the second interaction area.

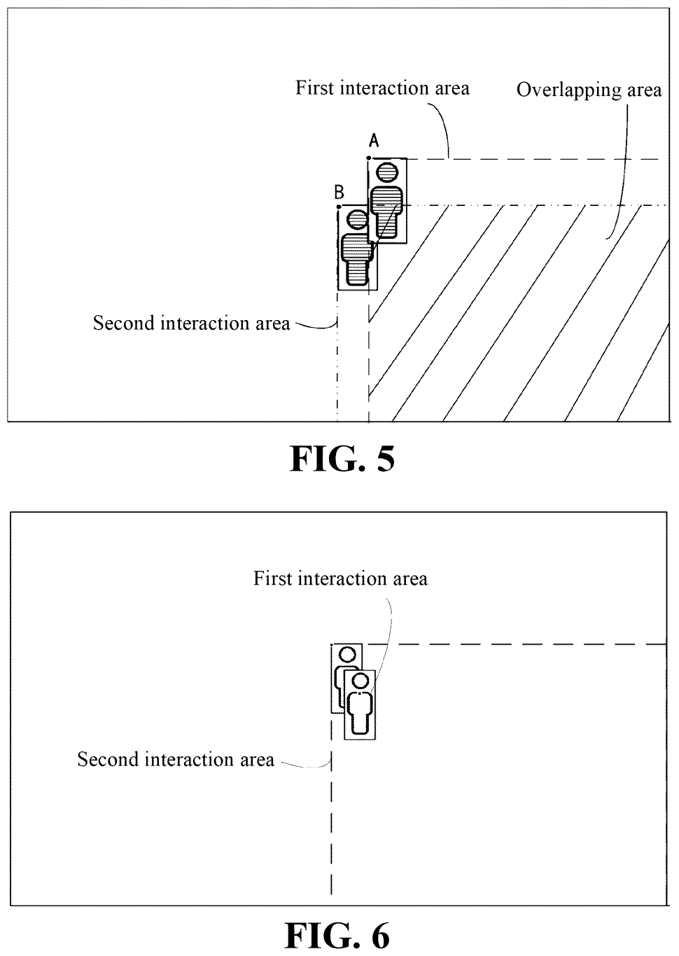

In some embodiments, multiple target objects may appear in the graphical user interface. When two target objects appear, namely the first object and the second object, the two target objects may be far apart or relatively close. When the two target objects are relatively close, the display area of the first object may easily block the display area of the second object, and the corresponding first interaction area of the first object and the second interaction area of the second object may overlap. Please refer to FIG. 5, where point A is the position point corresponding to the position information of the first object, point A is the vertex of the upper left corner of the interaction area of the first object, and forms a touchable rectangle with the lower right corner of the graphical user interface, namely the first interaction area. Similarly, point B in the figure is the position point corresponding to the position information of the second object, point B is the vertex of the upper left corner of the interaction area of the second object, and forms another touchable rectangle with the lower right corner of the graphical user interface, namely the second interaction area. Furthermore, the overlapping area between the first interaction area of the first object and the second interaction area of the second object can be determined. In the mode, since the display area of the first object blocks the display area of the second object, according to the same display hierarchy, the first interaction area blocks the second interaction area; the first object can be selected by executing a specified trigger operation in the first interaction area; since part of the second interaction area is blocked by the first interaction area, which is the overlapping area of the entire area, the second object can be selected only by executing the specified trigger operation in the remaining area outside the overlapping area in the second interaction area.

In another specific mode, the above-mentioned target object includes a first object and a second object; in response to the display area of the first object blocking the display area of the second object, a first interaction area of the first object is determined as the display area of the first object; where the first interaction area is used for: selecting the first object in response to a specified trigger operation; and the second object is selected in response to a specified trigger operation in the remaining area outside the display area of the first object in the second interaction area.

Taking FIG. 6 as an example, when two target objects appear in the graphical user interface and the display area of the first object blocks the display area of the second object, the first interaction area of the first object is determined as the display area of the first object. Since the display area of the first object blocks the display area of the second object, the display area of the first object is in an unblocked state, and the player can trigger the display area of the first object conveniently to select the first object. However, since the display area of the second object is blocked, it is not convenient for the player to select the second object through the display area of the second object. Based on this, the second object can be selected by executing the specified trigger operation in the remaining area outside the display area of the first object in the second interaction area.

In the above mode, when the first object blocks the second object, the first object is selected through the display area of the first object itself, and the second object is selected through the interaction area of the second object, which can improve the convenience and success rate of the selection operation of the blocked object.

The following embodiment continues to explain the specific implementation of selecting a target object when there are multiple target objects.

The above-mentioned target object includes a first object and a second object; the first object is provided with a first interaction area, and the second object is provided with a second interaction area; the first interaction area and the second interaction area have an overlapping area; in response to a specified trigger operation acting on the overlapping area, the hierarchical relationship between the first interaction area and the second interaction area is determined; where in the hierarchical relationship, the hierarchical levels of the first interaction area and the second interaction area are arranged in descending order; and the target object corresponding to the interaction area with the highest hierarchical level is determined as the selected target object.

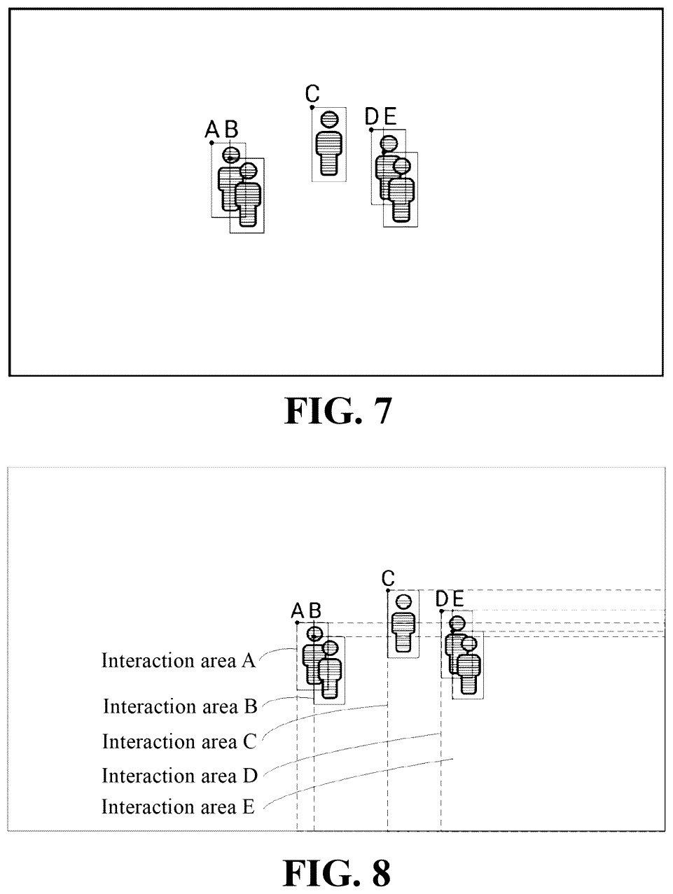

In some embodiments, multiple target objects may appear in the graphical user interface, as shown in FIG. 7. When multiple target objects appear in the graphical user interface, the interaction areas corresponding to the target objects may have overlapping areas, thereby affecting the player's selection of the target object. In order to allow the player to have good game experience, in this embodiment, in view of the situation where multiple target objects appear in the graphical user interface, the hierarchical relationship of the interaction areas corresponding to the target objects is pre-set, and the interaction area of each target object corresponds to an hierarchical level. When there is an overlapping area between the interaction areas of at least two target objects among the multiple target objects, for example, the target objects are the first object and the second object, and there is an overlapping area between the interaction areas of the first object and the second object, in response to a specified trigger operation acting on the overlapping area, the hierarchical relationship between the first interaction area and the second interaction area is determined. In this hierarchical relationship, at least the hierarchical levels between the first interaction area and the second interaction area can be arranged in descending order; then the target object corresponding to the interaction area with the highest hierarchical level is determined as the selected target object.

The interaction areas of the first object and the second object have an overlapping area, there may be overlapping areas between the interaction areas of all target objects appearing in the graphical user interface, or there may be overlapping areas between the interaction areas of some target objects. If the player executes a specified trigger operation on the overlapping area, in order to determine which target object is finally selected, it is necessary to set the hierarchical relationship between the interaction areas with overlapping areas. The hierarchical relationship may be determined based on the positional relationship between the target objects, or may be determined based on the order in which the target objects appear in the graphical user interface.

In the mode, by setting the hierarchical relationship of the interaction areas, when multiple target objects appear in the graphical user interface and there are overlapping areas between the interaction areas of the multiple target objects, the target object can also be accurately selected, thereby improving the game experience of the player.

In some embodiments, in response to a specified trigger operation acting on the overlapping area, a first object position of the first object and a second object position of the second object are determined; based on the positional relationship between the first object position and the second object position, the hierarchical relationship between the first interaction area and the second interaction area is determined.

In a mode or embodiment, when the interaction areas of the first object and the second object have an overlapping area, in response to a trigger operation acting on the overlapping area, the specified trigger operation may be implemented in a variety of ways, such as click, to determine the object position of the first object and the object position of the second object, where the object position may be the vertex position of the minimum rectangle, for example, the object position of the first object may be the upper left corner vertex position of the minimum rectangle of the capsule planar area of the first object, and the object position of the second object may be the upper left corner vertex position of the minimum rectangle of the capsule planar area of the second object. Then, based on the relationship between the object positions of the first object and the second object, and by comparing the relationship between the upper left corner vertex position of the minimum rectangle corresponding to the first object and the upper left corner vertex position of the minimum rectangle corresponding to the second object, the hierarchical relationship between the first interaction area and the second interaction area is determined.

The following embodiment continues to illustrate a specific implementation of determining the hierarchical relationship between the interaction areas of multiple target objects.

The graphical user interface is preset with a coordinate system; the coordinate system includes a coordinate axis in the horizontal direction and a coordinate axis in the vertical direction; the position located on the graphical user interface has a coordinate value in the horizontal direction and a coordinate value in the vertical direction; in the above-mentioned coordinate system, a first coordinate value of the first object position in the horizontal direction and a second coordinate value of the second object position in the horizontal direction are determined; based on a size relationship between the first coordinate value and the second coordinate value, the hierarchical relationship between multiple target interaction areas is determined.

Specifically, when multiple target objects appear in the graphical user interface, the interaction area of the target object includes a rectangular area formed by the object position of the target object and the datum position; where the object position and the datum position are corners opposite to each other in the rectangular area, and the interaction area corresponding to each target object is formed based on the above mode. Therefore, when multiple target objects appear in the graphical user interface, the interaction areas of the target objects may form overlapping areas.

In this embodiment, the hierarchical relationship between the interaction areas of the first object and the second object is determined based on the positional relationship between the object positions of the first object and the second object. Specifically, a coordinate system may be set on the graphical user interface, and the coordinate system includes a coordinate axis in the horizontal direction and a coordinate axis in the vertical direction. The coordinate values of at least two target objects in the horizontal direction are acquired, and the sizes of the horizontal coordinates of the object positions of the two target objects are compared. The larger the horizontal coordinate of the object position of the target object is, the higher the hierarchical level of the corresponding interaction area is. When at least two target objects appear in the graphical user interface, the hierarchical relationship between the interaction areas of the multiple target objects is set based on the same principle.

For ease of understanding, please refer to FIG. 8. When 5 target objects appear in the graphical user interface, the first position point corresponding to each target object is respectively point A, B, C, D, and E in order from left to right. The horizontal coordinates of the above first position points A, B, C, D, and E become larger successively. Therefore, the hierarchical relationship of the interaction areas corresponding to the above first position points A, B, C, D, and E is A<B<C<D<E. Based on this, by setting the hierarchical relationship of the interaction areas, even if there are overlapping areas of the interaction areas corresponding to multiple target objects, a certain target object can be accurately selected therefrom.

It should be noted that when players execute target selection operations, they usually click on the object display area of the target object. Due to the limited length of the player's fingers, they often click on the area to the right of the object display area. In this configuration, the operation position deviates. Through the setting method of the interaction area of this embodiment, the target object can be successfully selected even when there is a slight deviation in the player's operation position, thereby improving the convenience of the target selection operation.

In another specific mode, in response to a sliding operation acting on the overlapping area, the first object and the second object are selected; where the operation starting point or operation end point of the sliding operation is located in the overlapping area.

Specifically, when the first object and the second object appear in the graphical user interface, and the interaction areas of the first object and the second object have an overlapping area, when the player wants to select the first object and the second object at the same time, the player can perform a sliding operation in the overlapping area to select the first object and the second object at the same time. It should be noted that the operation starting point or operation end point of the sliding operation is located in the overlapping area.

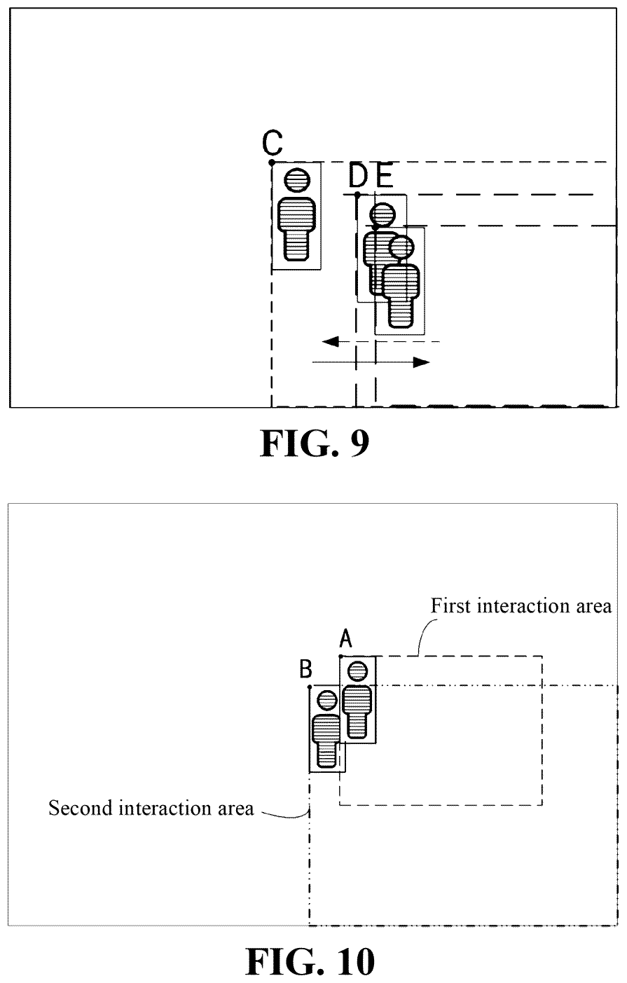

Similarly, when multiple target objects appear in the graphical user interface and the interaction areas corresponding to the multiple target objects have an overlapping area, if the player wants to select multiple target objects at the same time, the player can execute a sliding operation in the overlapping area to select the target object corresponding to the interaction area with the hierarchical relationship. The operation starting point or operation end point of the above-mentioned sliding operation is located in the overlapping area. For ease of understanding, please refer to FIG. 9. If the player wants to select the three target objects C, D, and E at the same time, he or she can slide starting from the overlapping area to the left to the interaction area corresponding to the target object C, such as sliding along the trajectory of the dotted arrow in FIG. 9, or he or she can slide starting from the interaction area corresponding to the target object C to the right to the overlapping area, such as sliding along the trajectory of the solid arrow in FIG. 9. Similarly, if the player wants to select target objects D and E, he or she can slide right from the interaction area corresponding to target object D to the overlapping area, or slide left from the overlapping area to the interaction area corresponding to target object D.

In some embodiments, there may be multiple target objects. When there are multiple target objects, an interaction area corresponding to each target object is set in the graphical user interface; when the interaction areas corresponding to the above-mentioned multiple objects have an overlapping area, if the player wants to select one of the target objects, the object can be accurately selected based on the above method. If the player wants to select multiple target objects, for example, the player wants to select the target objects corresponding to C, D, and E in the figure, at this time, the player executes a specified trigger operation in the interaction area, such as long-press, click, double-click, and an indicating arrow will be displayed in the graphical user interface, referring to FIG. 9, the player can execute a sliding operation along the direction of the indicating arrow. In response to the above-mentioned sliding operation, the target interaction area through which the sliding path of the sliding operation passes is determined, and the multiple target objects corresponding to the target interaction area are selected.

In the mode, when the number of target objects is large and the density is high, if the player wants to select multiple objects, he or she can execute a specified trigger operation, such as long-press, click, double-click, and an indicating arrow will appear in the graphical user interface. When the player executes a sliding operation according to the indicating arrow, the target object corresponding to the target interaction area passed by the sliding path is selected. Based on this, the operation of selecting multiple objects for players is simplified and the convenience of selecting multiple objects for players is improved.

Furthermore, in response to the area of the overlapping area being higher than a preset area threshold, the area edge position of the first interaction area and/or the second interaction area is adjusted so that the area of the overlapping area is lower than the preset area threshold.

In some embodiments, when there are multiple target objects appearing in the graphical user interface and there is an overlapping phenomenon, the position point for generating the interaction area of the target object can be adjusted. For example, a graphical user interface includes two target objects, namely a first object and a second object, and the interaction area of the first object and the interaction area of the second object have an overlapping area. Then, the area of the overlapping area between the interaction area of the first object and the interaction area of the second object is compared with a preset area threshold. If the area of the above-mentioned overlapping area is greater than the preset area threshold, the position point for generating the interaction area is adjusted.

Taking FIG. 10 as an example, when the area of the overlapping area of the first object and the second object is greater than the preset area threshold, the vertex of the lower right corner of the first interaction area, which is the edge position of the above-mentioned area, can be moved slightly to the upper left so that the area of the overlapping area is smaller than the preset area threshold. At this time, the degree of overlap between the interaction area of the first object and the interaction area of the second object is reduced to increase the success rate of the player accurately selecting the first object or the second object.

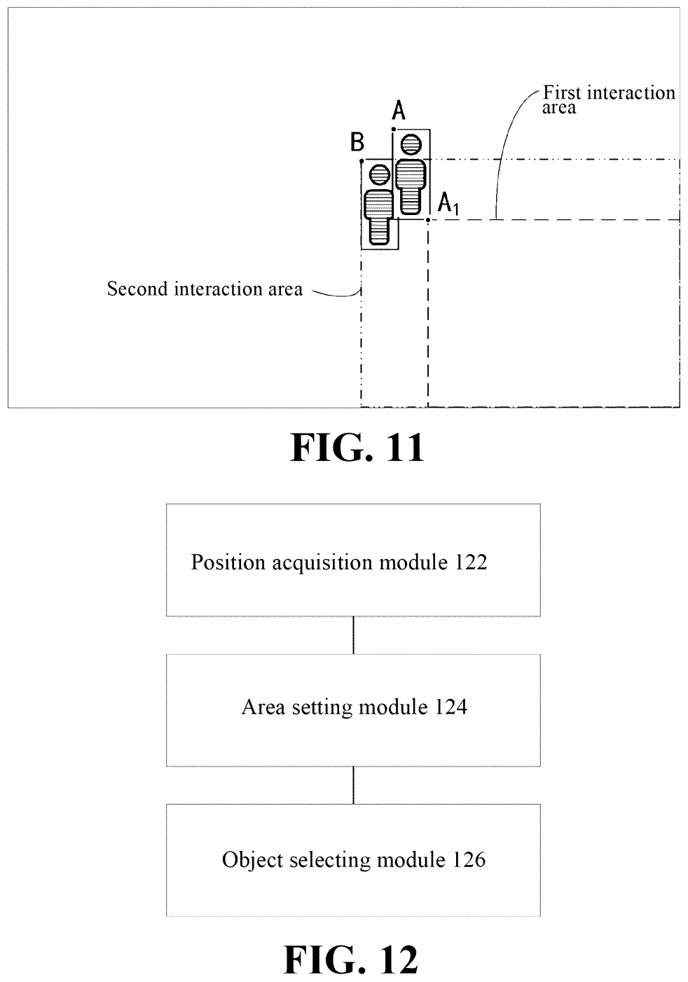

Taking FIG. 11 as another example, when the area of the overlapping area of the first object and the second object is greater than the preset area threshold, the vertex of the upper left corner of the first interaction area, which is the edge position of the above-mentioned area, can also be moved to the lower right corner of the display area of the target object, which is point A1. The first interaction area is set with point A1 as the upper left corner vertex of the first interaction area and the lower right corner of the graphical user interface as the lower right corner vertex of the first interaction area. At this time, the first interaction area does not include the display area of the target object. The player can choose to execute the specified trigger operation in the display area of the target object, or execute the specified trigger operation in the first interaction area. Based on this, all objects in the graphical user interface can be easily selected, further improving the success rate and convenience of players selecting objects.

In the mode, by adjusting the edge position of the interaction area, the overlapping degree of the interaction areas corresponding to multiple target objects is reduced, the success rate and convenience of the player selecting the object are improved, and the fun of the game experience is improved.

Furthermore, an area mark corresponding to the interaction area is displayed in the graphical user interface; where the area mark is used to: indicate the area position of the interaction area; and the mark display format of the area mark matches the object attribute of the target object corresponding to the interaction area.

In some embodiments, when a target object appears in the graphical user interface, an interaction area corresponding to the target object will be generated. When the number of target objects is small or the density is small, since a large interaction area corresponding to the target object is set, whether the interaction area of the target object is displayed in the graphical user interface at this time has little effect on the player's execution of the specified trigger operation, and it can be set by the player himself. When the number of target objects is large or the density is large, an area mark corresponding to the interaction area will be displayed in the graphical user interface. The area mark can indicate the area position of the interaction area corresponding to the target object, which can be specifically an area color or an area outline. The display format of the above area mark matches the object attribute of the target object corresponding to the interaction area. For example, if the area mark is an area color, then the color of the interaction area corresponding to each target object can be consistent with the color of the clothes worn by the model of the target object. For example, if the model of the target object wears pink clothes, then the interaction area corresponding to the target object has a pink translucent color; similarly, if the mark area is an area outline, then the interaction area of the target object can be outlined by the color of the clothes worn by the model of the target object.

In the mode, by setting the area mark corresponding to the interaction area, it is convenient for players to quickly distinguish the interaction area corresponding to each target object when multiple target objects appear in the graphical user interface, thereby improving the success rate and accuracy of the player's selection of the object.

For the above-mentioned method embodiment, referring to the schematic structural diagram of an apparatus for selecting an object shown in FIG. 12, a graphical user interface is provided through a terminal device, and the apparatus comprises:
a position acquisition module 122, configured to acquire, in response to a target object appearing in the graphical user interface, an object position of the target object in the graphical user interface;
an area setting module 124, configured to set, based on the object position, an interaction area corresponding to the target object in the graphical user interface; where the interaction area is larger than a display area of the target object in the graphical user interface, and the interaction area is used for: selecting, in response to a specified trigger operation, the target object;
an object selecting module 126, configured to select, in response to the specified trigger operation acting on the interaction area, the target object.

The above-mentioned apparatus for selecting an object, in response to a target object appearing in a graphical user interface, acquires an object position of the target object in the graphical user interface; based on the object position, sets an interaction area corresponding to the target object in the graphical user interface, where the interaction area is larger than a display area of the target object in the graphical user interface, and the interaction area is used for: selecting, in response to a specified trigger operation, the target object; and selects, in response to the specified trigger operation acting on the interaction area, the target object. An interaction area of the target object is set in the interface based on the object position of the target object. The interaction area is greater than the display area of the target object. The target object can be selected by triggering the interaction area. This method can expand the operable area for selecting an object, and the object can be selected conveniently and efficiently. The success rate of the operation for selecting the object is high, which reduces the operation burden of selecting an object, improves the game experience of the player, reduces the running time of the terminal device, and saves the power consumption of the terminal device.

The above-mentioned position acquisition module is also configured to: acquire, in response to the target object appearing in the graphical user interface, a capsule of the object model of the target object in the game scene; determine a capsule planar area of the capsule in the scene picture displayed in the graphical user interface, and determine a specified position point relative to the capsule planar area as the object position of the target object in the graphical user interface.

The above-mentioned position acquisition module is also configured to: determine a capsule planar area of the capsule in the scene picture displayed in the graphical user interface; and determine a position point in the direction of the upper left corner of the capsule planar area as the object position of the target object in the graphical user interface.

The above-mentioned position acquisition module is also configured to: in response to target objects appearing in the graphical user interface, perform statistics on the distribution state of the target objects appearing in the graphical user interface, where the distribution state includes the number and/or density of the target objects; in response to the distribution state satisfying a preset condition, acquire the object position of the target object in the graphical user interface.

The above-mentioned area setting module is also configured to: set, based on the object position and a datum position in the graphical user interface, an interaction area corresponding to the target object in the graphical user interface; where the datum position is used to determine the interaction area in the graphical user interface together with the object position.

The above-mentioned area setting module is also configured to: generate, with the object position and the datum position in the graphical user interface as reference positions, the interaction area of a specified shape; where the display area of the target object in the graphical user interface is included in the interaction area.

The datum position in the graphical user interface described above is located in the direction of the lower right corner of the graphical user interface; the above-mentioned area setting module is also configured to: generate, based on the object position and the datum position, a rectangular area; where the object position and the datum position are corners opposite to each other in the rectangular area; and the rectangular area is determined as the interaction area.

The above-mentioned target object includes a first object and a second object; the first object is provided with a first interaction area, and the second object is provided with a second interaction area; the first interaction area and the second interaction area have an overlapping area; the above-mentioned object selecting module is also configured to: determine. in response to a specified trigger operation acting on the overlapping area, the hierarchical relationship between the first interaction area and the second interaction area, where in the hierarchical relationship, the hierarchical levels of the first interaction area and the second interaction area are arranged in descending order; and the target object corresponding to the interaction area with the highest hierarchical level is determined as the selected target object.

The above-mentioned object selecting module is also configured to: determine, in response to a specified trigger operation acting on the overlapping area, a first object position of the first object and a second object position of the second object; determine, based on the positional relationship between the first object position and the second object position, the hierarchical relationship between the first interaction area and the second interaction area.

The above-mentioned graphical user interface is preset with a coordinate system; the coordinate system includes a coordinate axis in the horizontal direction and a coordinate axis in the vertical direction; the position located on the graphical user interface has a coordinate value in the horizontal direction and a coordinate value in the vertical direction; the above-mentioned object selecting module is also configured to: determine, in the coordinate system, a first coordinate value of the first object position in the horizontal direction and a second coordinate value of the second object position in the horizontal direction; determine, based on a size relationship between the first coordinate value and the second coordinate value, the hierarchical relationship between multiple target interaction areas.

The above-mentioned apparatus also includes: a sliding module, configured to: select, in response to a sliding operation acting on the overlapping area, the first object and the second object; where the operation starting point or operation end point of the sliding operation is located in the overlapping area.

The above-mentioned apparatus also includes: an adjustment module, configured to: adjust, in response to the area of the overlapping area being higher than a preset area threshold, the area edge position of the first interaction area and/or the second interaction area so that the area of the overlapping area is lower than the area threshold.

The above-mentioned apparatus also includes: a display module, configured to: display an area mark corresponding to the interaction area in the graphical user interface; where the area mark is used to: indicate the area position of the interaction area; and the mark display format of the area mark matches the object attribute of the target object corresponding to the interaction area.

The embodiment further provides an electronic device comprising a processor and a memory, where the memory stores machine-executable instructions executable by the processor, and the processor executes the machine-executable instructions to implement the above-mentioned method for selecting an object. The electronic device may be a server or a terminal device.

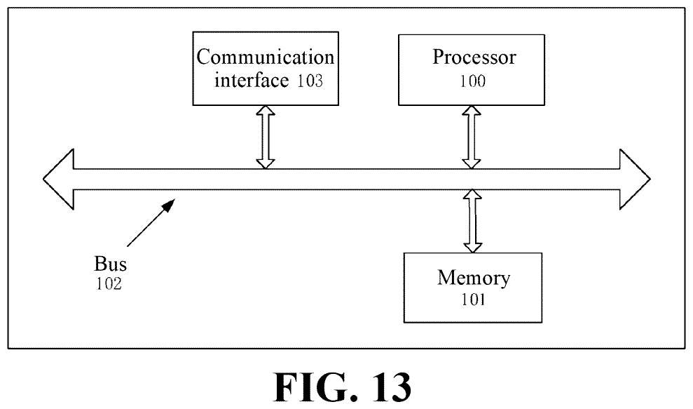

As shown in FIG. 13, the electronic device comprises a processor 100 and a memory 101, where the memory 101 stores machine-executable instructions executable by the processor 100, and the processor 100 executes the machine-executable instructions to implement the above-mentioned method for selecting an object, for example:
acquiring, in response to a target object appearing in a graphical user interface, an object position of the target object in the above-mentioned graphical user interface; setting, based on the object position, an interaction area corresponding to the target object in the graphical user interface, where the interaction area is larger than a display area of the target object in the graphical user interface, and the interaction area is used for: selecting, in response to a specified trigger operation, the target object; and selecting, in response to the specified trigger operation acting on the interaction area, the target object.

This method can expand the operable area for selecting an object, the object can be selected conveniently and efficiently, and the operation success rate of selecting an object is high, which reduces the operation burden of selecting an object, improves the game experience of the player, reduces the running time of the terminal device, and saves the power consumption of the terminal device.

In response to the target object appearing in the graphical user interface, a capsule of the object model of the target object in the game scene is acquired; a capsule planar area of the capsule in the scene picture displayed in the graphical user interface is determined, and position information of a specified position point relative to the capsule planar area is determined as the object position of the target object in the graphical user interface.

A capsule planar area of the capsule in the scene picture displayed in the graphical user interface is determined; and a position point in the direction of the upper left corner of the capsule planar area is determined as the object position of the target object in the graphical user interface.

In response to target objects appearing in the graphical user interface, statistics are performed on the distribution state of the target objects appearing in the graphical user interface; where the distribution state includes the number and/or density of the target objects; in response to the distribution state satisfying a preset condition, the object position of the target object in the graphical user interface is acquired.

In the above mode, the position information of the object is acquired only when there are many or dense objects, and then the interaction area is set based on the position information, thereby improving the success rate of the operation of selecting an object when there are many objects.

Based on the object position and a datum position in the graphical user interface, the interaction area corresponding to the target object is set in the graphical user interface; where the datum position is used to determine the interaction area in the graphical user interface together with the object position.

The object position and the datum position in the graphical user interface are used as reference positions to generate the interaction area of a specified shape; where the display area of the target object in the graphical user interface is included in the interaction area.

In the mode, the interaction area of a specified shape is generated by using the position point in the object position and the datum position as reference positions. The player can select the target object without moving the finger significantly, which improves the convenience of the player's operation of selecting an object.

The datum position in the graphical user interface is located in the direction of the lower right corner of the graphical user interface; based on the object position and the datum position, a rectangular area is generated; where the object position and the datum position are corners opposite to each other in the rectangular area; and the above-mentioned rectangular area is determined as the interaction area corresponding to the target object.

In the above mode, the interaction area of the target object is much greater than the display area of the target object, which makes it easier for the player to accurately select the target object.

The target object includes a first object and a second object; the first object is provided with a first interaction area, and the second object is provided with a second interaction area; the first interaction area and the second interaction area have an overlapping area; in response to a specified trigger operation acting on the overlapping area, the hierarchical relationship between the first interaction area and the second interaction area is determined; where in the hierarchical relationship, the hierarchical levels of the first interaction area and the second interaction area are arranged in descending order; and the target object corresponding to the interaction area with the highest hierarchical level is determined as the selected target object.

In the mode, by setting the hierarchical relationship of the interaction areas, when multiple target objects appear in the graphical user interface and there are overlapping areas between the interaction areas of the multiple target objects, the target object can also be accurately selected, thereby improving the game experience of the player.

In response to a specified trigger operation acting on the overlapping area, a first object position of the first object and a second object position of the second object are determined; based on the positional relationship between the first object position and the second object position, the hierarchical relationship between the first interaction area and the second interaction area is determined.

The graphical user interface is preset with a coordinate system; the coordinate system includes a coordinate axis in the horizontal direction and a coordinate axis in the vertical direction; the position located on the graphical user interface has a coordinate value in the horizontal direction and a coordinate value in the vertical direction; in the above-mentioned coordinate system, a first coordinate value of the first object position in the horizontal direction and a second coordinate value of the second object position in the horizontal direction are determined; based on a size relationship between the first coordinate value and the second coordinate value, the hierarchical relationship between multiple target interaction areas is determined.

In response to a sliding operation acting on the overlapping area, the first object and the second object are selected; where the operation starting point or operation end point of the sliding operation is located in the overlapping area.

In the mode, when the number of target objects is large and the density is high, if the player wants to select multiple objects, he or she can execute a specified trigger operation, such as long-press, click, double-click, and an indicating arrow will appear in the graphical user interface. When the player executes a sliding operation according to the indicating arrow, the target object corresponding to the target interaction area passed by the sliding path is selected. Based on this, the operation of selecting multiple objects for players is simplified and the convenience of selecting multiple objects for players is improved.

In response to the area of the overlapping area being higher than a preset area threshold, the area edge position of the first interaction area and/or the second interaction area is adjusted so that the area of the overlapping area is lower than the preset area threshold.

In the mode, by adjusting the edge position of the interaction area, the overlapping degree of the interaction areas corresponding to multiple target objects is reduced, the success rate and convenience of the player selecting the object are improved, and the fun of the game experience is improved.

An area mark corresponding to the interaction area is displayed in the graphical user interface; where the area mark is used to: indicate the area position of the interaction area; and the mark display format of the area mark matches the object attribute of the target object corresponding to the interaction area.

In the mode, by setting the area mark corresponding to the interaction area, it is convenient for players to quickly distinguish the interaction area corresponding to each target object when multiple target objects appear in the graphical user interface, thereby improving the success rate and accuracy of the player's selection of the object.

Furthermore, the electronic device shown in FIG. 13 further includes a bus 102 and a communication interface 103, and the processor 100, the communication interface 103 and the memory 101 are connected via the bus 102.

The memory 101 may include a high-speed random access memory (RAM), and may also include a non-volatile memory, such as at least one disk memory. Communication connection between a system network element and at least one other network element is realized through at least one communication interface 103 (which can be wired or wireless), and the Internet, a wide area network, a local network, a metropolitan area network and the like can be used. The bus 102 can be an ISA bus, a PCI bus, an EISA bus or the like. The buses can be divided into an address bus, a data bus, a control bus and the like. In order to facilitate representation, only one bidirectional arrow is used for representation in FIG. 13, but it does not indicate that there is only one bus or one type of bus.

The processor 100 may be an integrated circuit chip having a signal processing capability. In some embodiments, all steps of the method can be implemented through an integrated logic circuit of hardware in the processor 100 or instructions in a software form. The above-mentioned processor 100 can be a universal processor, including a Central Processing Unit (CPU), a Network Processor (NP) and the like; it can also be a Digital Signal Processor (DSP), an Application Specific Integrated Circuit (ASIC), a Field-Programmable Gate Array (FPGA) or other Programmable logic devices, discrete gates or transistor logic devices and discrete hardware assemblies. All the methods, steps and logic block diagrams disclosed in the embodiments of the present disclosure can be implemented or executed. The universal processor can be a microprocessor or the processor can also be any conventional processor and the like. The steps of the method disclosed in combination with the embodiment of the present disclosure can be directly embodied as the completion of execution by a hardware decoding processor, or the completion of execution by a combination of hardware and software modules in the decoding processor. The software modules can be located in a random access memory, a flash memory, a read-only memory, a programmable read-only memory or an electrically erasable programmable memory, a register and other mature storage media in the field. The storage medium is located in the memory 101, and the processor 100 reads the information in the memory 101 and completes the steps of the method of the above embodiment in combination with its hardware.

The embodiment further provides a machine-readable storage medium, which stores machine-executable instructions. When the machine-executable instructions are called and executed by a processor, the machine-executable instructions cause the processor to implement the above-mentioned method for selecting an object, for example:
acquiring, in response to a target object appearing in a graphical user interface, an object position of the target object in the above-mentioned graphical user interface; setting, based on the object position, an interaction area corresponding to the target object in the graphical user interface, where the interaction area is larger than a display area of the target object in the graphical user interface, and the interaction area is used for: selecting, in response to a specified trigger operation, the target object; and selecting, in response to the specified trigger operation acting on the interaction area, the target object.

This method can expand the operable area for selecting an object, the object can be selected conveniently and efficiently, and the operation success rate of selecting an object is high, which reduces the operation burden of selecting an object, improves the game experience of the player, reduces the running time of the terminal device, and saves the power consumption of the terminal device.

In response to the target object appearing in the graphical user interface, a capsule of the object model of the target object in the game scene is acquired; a capsule planar area of the capsule in the scene picture displayed in the graphical user interface is determined, and position information of a specified position point relative to the capsule planar area is determined as the object position of the target object in the graphical user interface.

A capsule planar area of the capsule in the scene picture displayed in the graphical user interface is determined; and a position point in the direction of the upper left corner of the capsule planar area is determined as the object position of the target object in the graphical user interface.

In response to target objects appearing in the graphical user interface, statistics are performed on the distribution state of the target objects appearing in the graphical user interface; where the distribution state includes the number and/or density of the target objects; in response to the distribution state satisfying a preset condition, the object position of the target object in the graphical user interface is acquired.

In the above mode, the position information of the object is acquired only when there are many or dense objects, and then the interaction area is set based on the position information, thereby improving the success rate of the operation of selecting an object when there are many objects.

Based on the object position and a datum position in the graphical user interface, the interaction area corresponding to the target object is set in the graphical user interface; where the datum position is used to determine the interaction area in the graphical user interface together with the object position.

The object position and the datum position in the graphical user interface are used as reference positions to generate the interaction area of a specified shape; where the display area of the target object in the graphical user interface is included in the interaction area.

In the mode, the interaction area of a specified shape is generated by using the position point in the object position and the datum position as reference positions. The player can select the target object without moving the finger significantly, which improves the convenience of the player's operation of selecting an object.

The datum position in the graphical user interface is located in the direction of the lower right corner of the graphical user interface; based on the object position and the datum position, a rectangular area is generated; where the object position and the datum position are corners opposite to each other in the rectangular area; and the above-mentioned rectangular area is determined as the interaction area corresponding to the target object.

In the above mode, the interaction area of the target object is much greater than the display area of the target object, which makes it easier for the player to accurately select the target object.

The target object includes a first object and a second object; the first object is provided with a first interaction area, and the second object is provided with a second interaction area; the first interaction area and the second interaction area have an overlapping area; in response to a specified trigger operation acting on the overlapping area, the hierarchical relationship between the first interaction area and the second interaction area is determined; where in the hierarchical relationship, the hierarchical levels of the first interaction area and the second interaction area are arranged in descending order; and the target object corresponding to the interaction area with the highest hierarchical level is determined as the selected target object.

In the mode, by setting the hierarchical relationship of the interaction areas, when multiple target objects appear in the graphical user interface and there are overlapping areas between the interaction areas of the multiple target objects, the target object can also be accurately selected, thereby improving the game experience of the player.

In response to a specified trigger operation acting on the overlapping area, a first object position of the first object and a second object position of the second object are determined; based on the positional relationship between the first object position and the second object position, the hierarchical relationship between the first interaction area and the second interaction area is determined.

The graphical user interface is preset with a coordinate system; the coordinate system includes a coordinate axis in the horizontal direction and a coordinate axis in the vertical direction; the position located on the graphical user interface has a coordinate value in the horizontal direction and a coordinate value in the vertical direction; in the above-mentioned coordinate system, a first coordinate value of the first object position in the horizontal direction and a second coordinate value of the second object position in the horizontal direction are determined; based on a size relationship between the first coordinate value and the second coordinate value, the hierarchical relationship between multiple target interaction areas is determined.

In response to a sliding operation acting on the overlapping area, the first object and the second object are selected; where the operation starting point or operation end point of the sliding operation is located in the overlapping area.

In the mode, when the number of target objects is large and the density is high, if the player wants to select multiple objects, he or she can execute a specified trigger operation, such as long-press, click, double-click, and an indicating arrow will appear in the graphical user interface. When the player executes a sliding operation according to the indicating arrow, the target object corresponding to the target interaction area passed by the sliding path is selected.

Based on this, the operation of selecting multiple objects for players is simplified and the convenience of selecting multiple objects for players is improved.

In response to the area of the overlapping area being higher than a preset area threshold, the area edge position of the first interaction area and/or the second interaction area is adjusted so that the area of the overlapping area is lower than the preset area threshold.

In the mode, by adjusting the edge position of the interaction area, the overlapping degree of the interaction areas corresponding to multiple target objects is reduced, the success rate and convenience of the player selecting the object are improved, and the fun of the game experience is improved.

An area mark corresponding to the interaction area is displayed in the graphical user interface; where the area mark is used to: indicate the area position of the interaction area; and the mark display format of the area mark matches the object attribute of the target object corresponding to the interaction area.

In the mode, by setting the area mark corresponding to the interaction area, it is convenient for players to quickly distinguish the interaction area corresponding to each target object when multiple target objects appear in the graphical user interface, thereby improving the success rate and accuracy of the player's selection of the object.

The computer program products of the method, apparatus and system for selecting an object provided in the embodiments of the present disclosure include a computer-readable storage medium storing a program code. The instructions included in the program code can be used to execute the methods described in the previous method embodiments. The specific implementation can be found in the method embodiments, which will not be repeated here.

Those skilled in the art can clearly understand that, for the convenience and brevity of description, for the specific working process of the system and device described above, reference can be made to the corresponding process in the aforementioned method embodiments, which will not be repeated here.

In addition, in the description of the embodiments of the present disclosure, unless otherwise clearly specified and limited, the terms “install”, “link” and “connect” should be understood in a broad sense. For example, it can be a fixed connection, a detachable connection, or an integral connection; it can be a mechanical connection or an electrical connection; it can be a direct connection or an indirect connection through an intermediate medium, and it can be the internal communication of two elements. For those skilled in the art, the specific meanings of the above terms in the present disclosure can be understood on a case-by-case basis.

If the function is implemented in a software function unit mode and is sold or used as an independent product, it can be stored in a computer-readable storage medium. Based on such an understanding, the technical solutions of the present disclosure essentially, or the part contributing to the related art, or a part of the technical solution may be implemented in the form of a software product. The computer software product may be stored in a storage medium, and includes several instructions for instructing a computer device (which may be a personal computer, a server, a network device or the like) to perform all or a part of the steps in the methods described in the embodiments of the present disclosure. The aforementioned storage medium includes: a USB flash disk, a mobile hard disk, a Read-Only Memory (ROM), a Random Access Memory (RAM), a magnetic disk, an optical disc, or other mediums that can store program codes.

In the description of the present disclosure, it is to be noted that the terms “center”, “up”, “down”, “left”, “right”, “vertical”, “horizontal”, “inner”, “outer”, etc., indicate the orientation or positional relationship based on the orientation or positional relationship shown in the drawing, and are only for the convenience of description of the present disclosure and for the purpose of simplifying the description, and do not indicate or imply that the device or element referred to must have a specific orientation, be constructed and operated in a particular orientation, and therefore cannot be construed as limiting the present disclosure. In addition, the terms “first”, “second”, “third” are used for descriptive purposes only and should not be construed as indicating or implying relative importance.

Finally, it is to be noted that the above-mentioned embodiments are only specific embodiments of the present disclosure, which are used for illustrating the technical solutions of the present disclosure, not to limit them, and the scope of protection of the present disclosure is not limited to this. Although the present disclosure is described in detail with reference to the above embodiments, those skilled in the art should understand that any person skilled in the art who is familiar with the art can still modify the technical solutions described in the aforesaid embodiments or can easily think of changes or equivalent substitutions of some of the technical features within the scope of the technology disclosed in the disclosure; however, these modifications, changes or substitutions do not depart from the essence of the corresponding technical solution from the spirit and scope of the technical solution of the embodiments of the present disclosure, and shall be covered by the scope of protection of the present disclosure. Therefore, the scope of protection of the present disclosure should be based on the scope of protection of the claims.

1. A method for selecting an object, the method comprising:
acquiring, in response to a target object appearing in a graphical user interface of a terminal device, an object position of the target object in the graphical user interface;
setting, based on the object position, an interaction area corresponding to the target object in the graphical user interface, wherein the interaction area is larger than a display area of the target object in the graphical user interface; and
selecting, in response to a specified trigger operation acting on the interaction area, the target object.

2. The method according to claim 1, wherein acquiring, in response to the target object appearing in the graphical user interface, the object position of the target object in the graphical user interface comprises:
acquiring, in response to the target object appearing in the graphical user interface, a capsule corresponding to an object model of the target object in a game scene;
determining a capsule planar area of the capsule in a scene picture displayed in the graphical user interface; and
determining a specified position point relative to the capsule planar area as the object position of the target object in the graphical user interface.

3. The method according to claim 2, wherein determining the specified position point relative to the capsule planar area as the object position of the target object in the graphical user interface comprises:
determining a position point in a upper left corner of the capsule planar area as the object position of the target object in the graphical user interface.

4. The method according to claim 1, wherein acquiring, in response to the target object appearing in the graphical user interface, the object position of the target object in the graphical user interface comprises:
in response to the target object appearing in the graphical user interface, determining a distribution state of one or more relevant target objects appearing in the graphical user interface, wherein the distribution state comprises at least one of a number or a density of the one or more relevant target objects; and
acquiring, in response to the distribution state satisfying a preset condition, the object position of the target object in the graphical user interface.

5. The method according to claim 1, wherein setting, based on the object position, the interaction area corresponding to the target object in the graphical user interface comprises:
setting, based on the object position and a datum position in the graphical user interface, the interaction area corresponding to the target object in the graphical user interface.

6. The method according to claim 5, wherein setting, based on the object position and the datum position in the graphical user interface, the interaction area corresponding to the target object in the graphical user interface comprises:
generating the interaction area with a specified shape using the object position and the datum position in the graphical user interface as reference positions, wherein the display area of the target object in the graphical user interface is included in the interaction area.

7. The method according to claim 6, wherein the datum position in the graphical user interface is located in a lower right corner of the graphical user interface, and
generating the interaction area with the specified shape using the object position and the datum position in the graphical user interface as reference positions comprises:
generating, based on the object position and the datum position, a rectangular area, wherein the object position and the datum position are corners opposite to each other in the rectangular area; and
determining the rectangular area as the interaction area.

8. The method according to claim 1, wherein the target object comprises a first object and a second object, the first object is provided with a first interaction area, the second object is provided with a second interaction area, an overlapping area exists between the first interaction area and the second interaction area, and
selecting, in response to the specified trigger operation acting on the interaction area, the target object comprises:
determining, in response to the specified trigger operation acting on the overlapping area, a hierarchical relationship between the first interaction area and the second interaction area, wherein the hierarchical relationship arranges the first interaction area and the second interaction area in a descending order, from highest to lowest, in terms of hierarchical levels; and
determining a target object corresponding to an interaction area with a highest hierarchical level as the selected target object.

9. The method according to claim 8, wherein determining, in response to the specified trigger operation acting on the overlapping area, the hierarchical relationship between the first interaction area and the second interaction area comprises:
determining, in response to the specified trigger operation acting on the overlapping area, a first object position of the first object and a second object position of the second object; and
determining, based on a positional relationship between the first object position and the second object position, the hierarchical relationship between the first interaction area and the second interaction area.

10. The method according to claim 9, wherein the graphical user interface is configured with a coordinate system, the coordinate system comprises a coordinate axis in the horizontal direction and a coordinate axis in the vertical direction, a position on the graphical user interface has a coordinate value in the horizontal direction and a coordinate value in the vertical direction, and
determining, based on the positional relationship between the first object position and the second object position, the hierarchical relationship between the first interaction area and the second interaction area comprises:
in the coordinate system, determining a first coordinate value of the first object position in the horizontal direction and a second coordinate value of the second object position in the horizontal direction; and
determining, based on a size relationship between the first coordinate value and the second coordinate value, the hierarchical relationship between the the first interaction area and the second interaction area.

11. The method according to claim 8, wherein the method further comprises:
selecting, in response to a sliding operation acting on the overlapping area, the first object and the second object, wherein the overlapping area comprises at least one of an operation starting point of the sliding operation or an operation end point of the sliding operation.

12. The method according to claim 8, wherein the method further comprises:
in response to an area of the overlapping area exceeding a preset area threshold; and
adjusting at least one of an edge position of the first interaction area or an edge position of the second interaction area, wherein the adjustment reduces the area of the overlapping area to below the preset area threshold.

13. The method according to claim 1, wherein after setting, based on the object position, the interaction area corresponding to the target object in the graphical user interface, the method further comprises:
displaying an area mark corresponding to the interaction area in the graphical user interface, wherein the area mark is used to indicate a position of the interaction area, and a display format of the area mark matches an object attribute of the target object corresponding to the interaction area.

14. (canceled)

15. A system, comprising:
one or more memories collectively containing one or more programs; and
one or more processors, wherein the one or more processors are configured to, individually or collectively, perform an operation comprising:
acquiring, in response to a target object appearing in a graphical user interface of a terminal device, an object position of the target object in the graphical user interface;
setting, based on the object position, an interaction area corresponding to the target object in the graphical user interface, wherein the interaction area is larger than a display area of the target object in the graphical user interface; and
selecting, in response to a specified trigger operation acting on the interaction area, the target object.

16. One or more non-transitory computer-readable storage media containing, in any combination, computer program code that, when executable by a computer system, perform an operation comprising:
acquiring, in response to a target object appearing in a graphical user interface of a terminal device, an object position of the target object in the graphical user interface;
setting, based on the object position, an interaction area corresponding to the target object in the graphical user interface, wherein the interaction area is larger than a display area of the target object in the graphical user interface; and
selecting, in response to a specified trigger operation acting on the interaction area, the target object.

17. The system according to claim 15, wherein acquiring, in response to the target object appearing in the graphical user interface, the object position of the target object in the graphical user interface comprises:
acquiring, in response to the target object appearing in the graphical user interface, a capsule corresponding to an object model of the target object in a game scene;
determining a capsule planar area of the capsule in a scene picture displayed in the graphical user interface; and
determining a specified position point relative to the capsule planar area as the object position of the target object in the graphical user interface.

18. The system according to claim 15, wherein acquiring, in response to the target object appearing in the graphical user interface, the object position of the target object in the graphical user interface comprises:
in response to the target object appearing in the graphical user interface, determining a distribution state of one or more relevant target objects appearing in the graphical user interface, wherein the distribution state comprises at least one of a number or a density of the one or more relevant target objects; and
acquiring, in response to the distribution state satisfying a preset condition, the object position of the target object in the graphical user interface.

19. The system according to claim 15, wherein setting, based on the object position, the interaction area corresponding to the target object in the graphical user interface comprises:
setting, based on the object position and a datum position in the graphical user interface, the interaction area corresponding to the target object in the graphical user interface.

20. The system according to claim 15, wherein the target object comprises a first object and a second object, the first object is provided with a first interaction area, the second object is provided with a second interaction area, an overlapping area exists between the first interaction area and the second interaction area, and
selecting, in response to the specified trigger operation acting on the interaction area, the target object comprises:
determining, in response to the specified trigger operation acting on the overlapping area, a hierarchical relationship between the first interaction area and the second interaction area, wherein the hierarchical relationship arranges the first interaction area and the second interaction area in a descending order, from highest to lowest, in terms of hierarchical levels; and
determining a target object corresponding to an interaction area with a highest hierarchical level as the selected target object.

21. The system according to claim 15, wherein after setting, based on the object position, the interaction area corresponding to the target object in the graphical user interface, the operation further comprises:
displaying an area mark corresponding to the interaction area in the graphical user interface, wherein the area mark is used to indicate a position of the interaction area, and a display format of the area mark matches an object attribute of the target object corresponding to the interaction area.
